(19) United States
(12) Patent Application Publication
(10) Pub. No.: US 2026/0316205 A1
(43) Pub. Date: Oct. 15, 2026

(54) PALLET TIP-OVER RESTRAINT MECHANISM AND AUTOMATIC PALLET CHANGER

(71) Applicant: OKUMA CORPORATION, Niwa-Gun (JP)

(72) Inventor: Koji TSUCHIDA, Niwa-Gun (JP)

(73) Assignee: OKUMA CORPORATION, Niwa-Gun (JP)

(21) Appl. No.: 19/467,927

(22) Filed: Feb. 3, 2026

(30) Foreign Application Priority Data
Feb. 14, 2025 (JP) 2025-022761

(51) Int. Cl. B23Q 7/14

(52) U.S. Cl. CPC B23Q 7/1431

(57) ABSTRACT

A pallet tip-over restraint mechanism in an automatic pallet changer includes a locking portion disposed on a lower surface of a fork portion and an unlocking portion. The locking portion includes a biasing unit and an input and output shaft disposed to be movable backward and forward in an axial direction with rotation in a tangential direction restricted and engageable with a pallet at an advanced position. The unlocking portion includes a cylinder rod disposed at a position in front of the input and output shaft with a turning arm descended and movable between a protruding position and a retracted position. The cylinder rod pushes the input and output shaft into a retracted position to release engagement of the pallet with the input and output shaft at the protruding position. The cylinder rod at the retracted position is separated from the input and output shaft at the advanced position.

### CROSS REFERENCE TO RELATED APPLICATION

This application claims the benefit of Japanese Patent Application Number 2025-022761 filed on Feb. 14, 2025, the entirety of which is incorporated by reference.

### FIELD OF THE INVENTION

The disclosure relates to a pallet tip-over restraint mechanism that can inhibit a pallet from tipping over, which may occur in an automatic pallet changer disposed in a machine tool, and reduce failures, such as misalignment, inclination, and drop, and an automatic pallet changer.

### BACKGROUND OF THE INVENTION

In a horizontal machining center equipped with an automatic pallet changer (hereinafter referred to as APC), generally, an APC fork that loads pallets on both sides turns, thereby realizing pallet exchange between a setup station side and a machining chamber. Since the pallet exchange time is non-cutting time, the turning speed of the APC fork is increased as much as possible to shorten the pallet exchange time for the purpose of improving productivity. The pallet simply rests on the APC fork. Therefore, if the moment of gravity and centrifugal force is out of balance when the APC fork turns, the pallet will tip over. If the pallet tips over, a workpiece may collide with the cover of the APC, which may take a long time to recover. Therefore, in order to inhibit a pallet from tipping over, for example, the center of gravity position of a pallet that can be loaded on the APC is clearly indicated in the operating manual. However, many users do not know the center of gravity of the pallet and workpiece in detail. Therefore, as a result of installing a workpiece whose center of gravity is outside the allowable range, there are not a few cases where the pallet tips over when the APC fork turns.

As an anti-tipping measure for a pallet, for example, as illustrated in FIG. 7, hooks 101 are attached to positions of a back surface of a pallet 100, where the pallet 100 can be rotated within an APC fork 102 in some cases. By taking the anti-tipping measure, even if the pallet 100 is about to tip over when the APC fork 102 turns, the hooks 101 can get caught on the APC fork 102, inhibiting the pallet 100 from tipping over.

On the other hand, for the purpose of improving productivity, for example, the introduction of a flexible manufacturing system (hereinafter referred to as FMS) may be considered. When an FMS is introduced and pallets go back and forth between machine tables, it is necessary to carry out a pallet on an APC on a setup station side. At this time, in the FMS, as illustrated in FIG. 8, an FMS arm 103 generally lifts the pallet 100 from below. However, the use of the hooks 101 as a pallet tip-over restraint device as described above cannot be adopted because the hooks 101 get caught on the FMS arm 103 when the FMS arm 103 lifts the pallet 100 from the lower side. For this reason, there are many examples of pallet tip-over restraint devices not being installed in existing horizontal machining centers, even when an FMS is introduced. However, unless a pallet tip-over restraint device is installed, there is concern that even if productivity improvement by the FMS is attempted, pallets may tip over depending on a mounted workpiece, and production efficiency might not increase.

Therefore, in JP7152335B, the applicant discloses an APC that can release a tip-over restraint device using an air cylinder. A pallet tip-over restraint mechanism disposed in the APC described in JP7152335B includes an output shaft disposed in a fork portion to be movable backward and forward in an axial direction and an input shaft disposed to be movable backward and forward in parallel and integrally with the output shaft. The output shaft is engageable with a hook disposed on a pallet lower surface at an advanced position. In addition, the pallet tip-over restraint mechanism includes a coil spring disposed in the fork portion and an external cylinder disposed at a position on an extended line of the input shaft with a turning arm descended and including a piston rod movable between a protruding position and a retracted position. The coil spring biases the output shaft to the advanced position. The piston rod pushes the input shaft into a retracted position from the advanced position to release engagement of the hook of the pallet with the output shaft at the protruding position. The piston rod at the retracted position is separated from the input shaft at the advanced position.

In the tip-over restraint device in JP7152335B, the piston rod is positioned at the retracted position in normal operation when a pallet is loaded on the fork portion. In this state, the output shaft is engaged with the hook on the lower surface of the pallet, inhibiting the pallet from tipping over.

On the other hand, when the pallet tip-over restraint is released, the piston rod moves to the protruding position while compressing the coil spring that biases the input shaft to the advanced position. Specifically, the input shaft moves from the advanced position to the retracted position. At this time, since the output shaft connected to the input shaft via an adapter also moves simultaneously, the engagement state between the output shaft and the hook on the pallet lower surface is released. As long as the engagement state between the output shaft and the hook on the pallet lower surface is released, the tip-over restraint device will not get caught on the hook on the pallet lower surface when the pallet is lifted.

However, in the above conventional tip-over restraint device, the input shaft and the output shaft are arranged in an up-down direction. Accordingly, for example, even if an APC equipped with the above conventional tip-over restraint device is applied to a small machine tool, depending on the base structure of the APC, it may not be possible to secure a space in the up-down direction that allows the input shaft and the output shaft to be arranged. In this case, the APC equipped with the above conventional tip-over restraint device cannot be applied.

Therefore, it is an object of the disclosure to provide a pallet tip-over restraint mechanism that are applicable to an APC with a restriction in an up-down direction and are excellent in durability and dust-proof performance, and an automatic pallet changer.

### SUMMARY OF THE INVENTION

In order to solve the above-described issue, a first configuration of the disclosure provides a pallet tip-over restraint mechanism disposed in an automatic pallet changer. The automatic pallet changer includes a turning arm with fork portions at both ends of the turning arm on a base of the automatic pallet changer and is configured to exchange a pallet loaded on the fork portion by horizontal turning and ascent and descent operations of the turning arm. The pallet tip-over restraint mechanism engages with the pallet when the turning arm turns horizontally to inhibit the pallet from tipping over. The pallet tip-over restraint mechanism includes a locking portion disposed on a lower surface of the fork portion and an unlocking portion disposed below the fork portion. The locking portion includes an input and output shaft and a biasing unit. The input and output shaft is disposed to be movable backward and forward in an axial direction with rotation in a tangential direction restricted and engageable with the pallet at an advanced position. The biasing unit biases the input and output shaft to the advanced position. The unlocking portion includes, on a base, a cylinder rod disposed at a position in front of the input and output shaft with the turning arm descended and movable between a protruding position and a retracted position. The cylinder rod pushes the input and output shaft into a retracted position from the advanced position to release engagement of the pallet with the input and output shaft at the protruding position. The cylinder rod at the retracted position is separated from the input and output shaft at the advanced position.

In another aspect of the first configuration of the disclosure, which is in the above-described configuration, in the locking portion, the input and output shaft and the biasing unit are housed in a case disposed on the lower surface side of the fork portion, except for a forward end of the input and output shaft, and the forward end of the input and output shaft is sealed with a shielding member. In the unlocking portion, the cylinder rod is housed in a tip-over restraint release cylinder disposed on the base, except for a forward end thereof, and the forward end of the cylinder rod is sealed with a shielding member.

In another aspect of the first configuration of the disclosure, which is in the above-described configuration, the locking portion includes an anti-rotation shaft housed in the case and disposed to be movable backward and forward integrally with the input and output shaft, the anti-rotation shaft restricting rotation of the input and output shaft in the tangential direction.

In another aspect of the first configuration of the disclosure, which is in the above-described configuration, the input and output shaft is coupled in parallel to the anti-rotation shaft.

In another aspect of the first configuration of the disclosure, which is in the above-described configuration, the input and output shaft is horizontally arranged side by side with the anti-rotation shaft.

In order to solve the above-described issue, a second configuration of the disclosure provides an automatic pallet changer including a turning arm with fork portions at both ends of the turning arm on a base of the automatic pallet changer and being configured to exchange a pallet loaded on the fork portion by horizontal turning and ascent and descent operations of the turning arm. The automatic pallet changer includes a pallet tip-over restraint mechanism engaging with the pallet when the turning arm turns horizontally to inhibit the pallet from tipping over. The pallet tip-over restraint mechanism includes a locking portion disposed on a lower surface of the fork portion and an unlocking portion disposed below the fork portion. The locking portion includes an input and output shaft and a biasing unit, the input and output shaft is disposed to be movable backward and forward in an axial direction with rotation in a tangential direction restricted and engageable with the pallet at an advanced position. The biasing unit biases the input and output shaft to the advanced position. The unlocking portion includes, on a base, a cylinder rod disposed at a position in front of the input and output shaft with the turning arm descended and movable between a protruding position and a retracted position. The cylinder rod pushes the input and output shaft into a retracted position from the advanced position to release engagement of the pallet with the input and output shaft at the protruding position. The cylinder rod at the retracted position is separated from the input and output shaft at the advanced position.

In another aspect of the second configuration of the disclosure, which is in the above-described configuration, in the locking portion, the input and output shaft and the biasing unit are housed in a case disposed on the lower surface side of the fork portion, except for a forward end of the input and output shaft, and the forward end of the input and output shaft is sealed with a shielding member. In the unlocking portion, the cylinder rod is housed in a tip-over restraint release cylinder disposed on the base, except for a forward end thereof, and the forward end of the cylinder rod is sealed with a shielding member.

In another aspect of the second configuration of the disclosure, which is in the above-described configuration, the locking portion includes an anti-rotation shaft housed in the case and disposed to be movable backward and forward integrally with the input and output shaft, the anti-rotation shaft restricting rotation of the input and output shaft in the tangential direction.

In another aspect of the second configuration of the disclosure, which is in the above-described configuration, the input and output shaft is coupled in parallel to the anti-rotation shaft.

In another aspect of the second configuration of the disclosure, which is in the above-described configuration, the input and output shaft is horizontally arranged side by side with the anti-rotation shaft.

According to the disclosure, the pallet tip-over restraint mechanism includes a locking portion including an input and output shaft with rotation in a tangential direction restricted and an unlocking portion including a cylinder rod that moves the input and output shaft. Accordingly, the pallet tip-over restraint mechanism becomes compact in a height direction and can be installed with a small space. Therefore, the pallet tip-over restraint mechanism and the automatic pallet changer of the disclosure can also be applied to an APC with a restriction in an up-down direction.

In addition, the input and output shaft and the cylinder rod are disposed on a coaxial extended line. Accordingly, no edge loading occurs on a plain bearing. Therefore, the pallet tip-over restraint mechanism and the automatic pallet changer of the disclosure are excellent in durability.

Furthermore, the input and output shaft and the cylinder rod are sealed with dust seals. Therefore, the pallet tip-over restraint mechanism and the automatic pallet changer of the disclosure are also excellent in dust-proof performance.

### BRIEF DESCRIPTION OF THE DRAWINGS

FIG. 1 is an explanatory view illustrating an automatic pallet changer viewed from a setup station side.

FIG. 2 is an explanatory view that omits a turning arm and a base from FIG. 1.

FIG. 3 is an enlarged explanatory view in which an inside of a circular frame A in FIG. 2 is enlarged.

FIG. 4 is a horizontal cross-sectional view of a pallet tip-over restraint mechanism part in a locked state.

FIG. 5 is a horizontal cross-sectional view of the pallet tip-over restraint mechanism part in an unlocked state.

FIG. 6 is an enlarged explanatory view illustrating a case in which a mechanism inside the circular frame A in FIG. 2 is in the unlocked state.

FIG. 7 is an explanatory view illustrating a conventional pallet prevention measure.

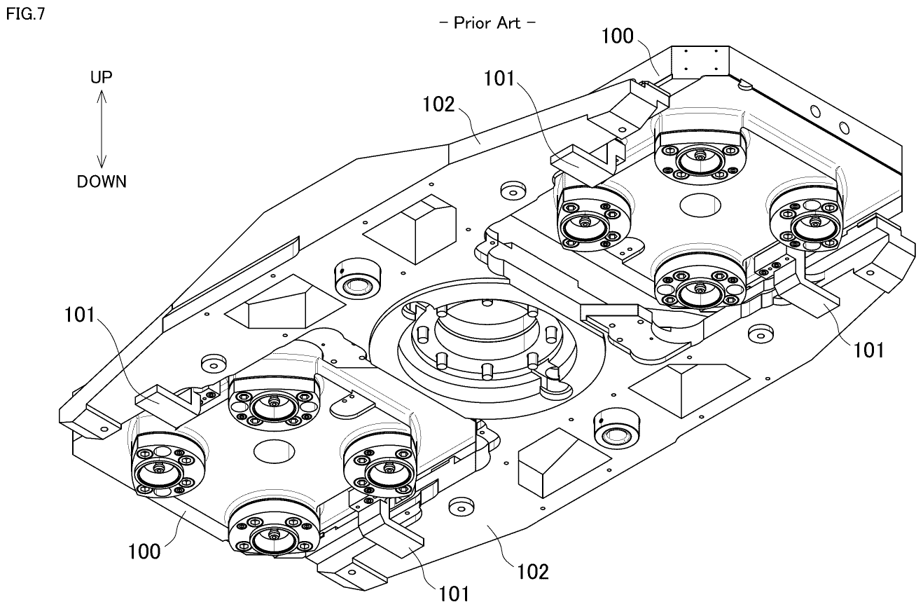

FIG. 8 is an explanatory view illustrating a state of pallet exchange by an FMS.

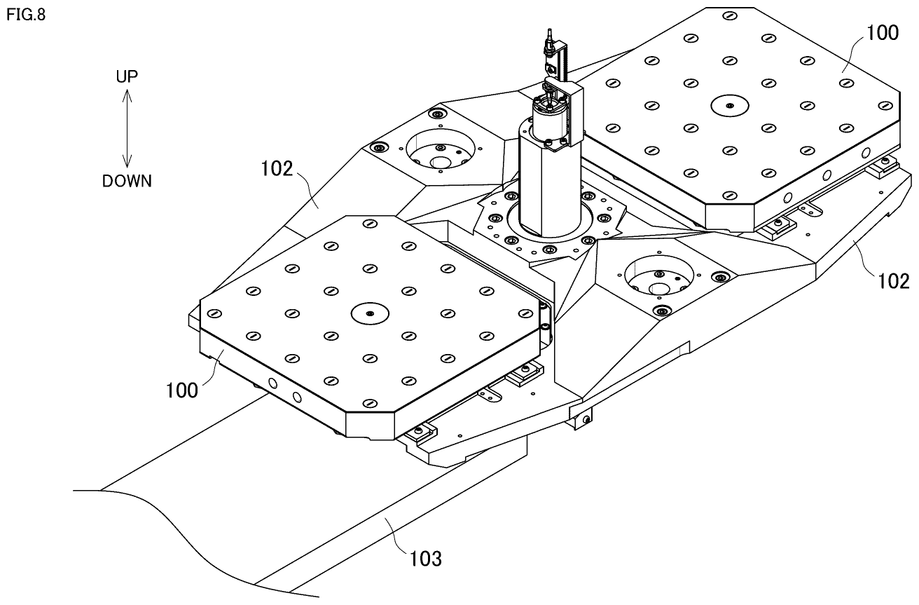

### DETAILED DESCRIPTION OF THE INVENTION

The following describes embodiments of the disclosure based on the drawings.

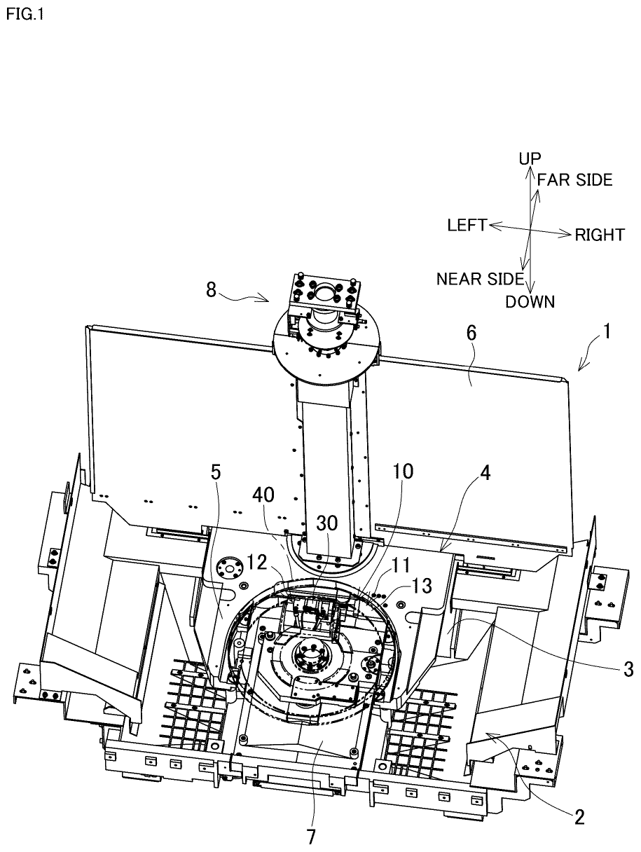

FIG. 1 illustrates an automatic pallet changer 1 disposed in a horizontal machining center from a setup station 2 side. The automatic pallet changer 1 includes a turning arm 4 that can turn horizontally around a pivot shaft 8 on a base 3 by a motor and an ascent and descent mechanism (not illustrated) and that performs ascent and descent operations. The automatic pallet changer 1 exchanges a pallet 40 between a machining chamber and the setup station 2 by the turning arm 4. Turning of the turning arm 4 is performed with the turning arm 4 ascended. A fork portion 5 on which the pallet 40 is loaded and supported is disposed at each of both ends of the turning arm 4. In FIG. 1, only one end side of the fork portion 5 is illustrated. A partition cover 6 that partitions between the machining chamber and the setup station 2 is provided on an upper surface of the turning arm 4. The representation on the machining chamber side of the partition cover 6 is omitted in FIG. 1.

As illustrated in FIGS. 1, 2, and 3, a pallet tip-over restraint mechanism 10 is disposed in the automatic pallet changer 1 so as not to cause the pallet 40 to tip over from the fork portion 5, resulting in failures, such as misalignment, inclination, and drop, when the turning arm 4 turns for exchanging the pallet 40. The pallet tip-over restraint mechanism 10 includes a locking portion 11 disposed on a lower surface of the fork portion 5 and an unlocking portion 12 disposed on a base 7 of the setup station 2.

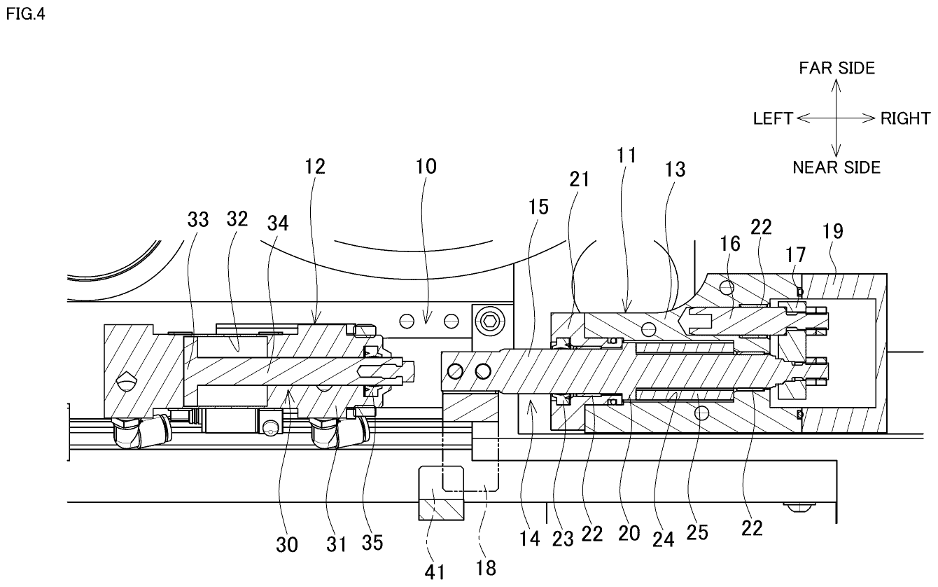

As illustrated in FIG. 4, the locking portion 11 includes a case 13 fixed on the lower surface of the fork portion 5 and a locking body 14 housed in the case 13.

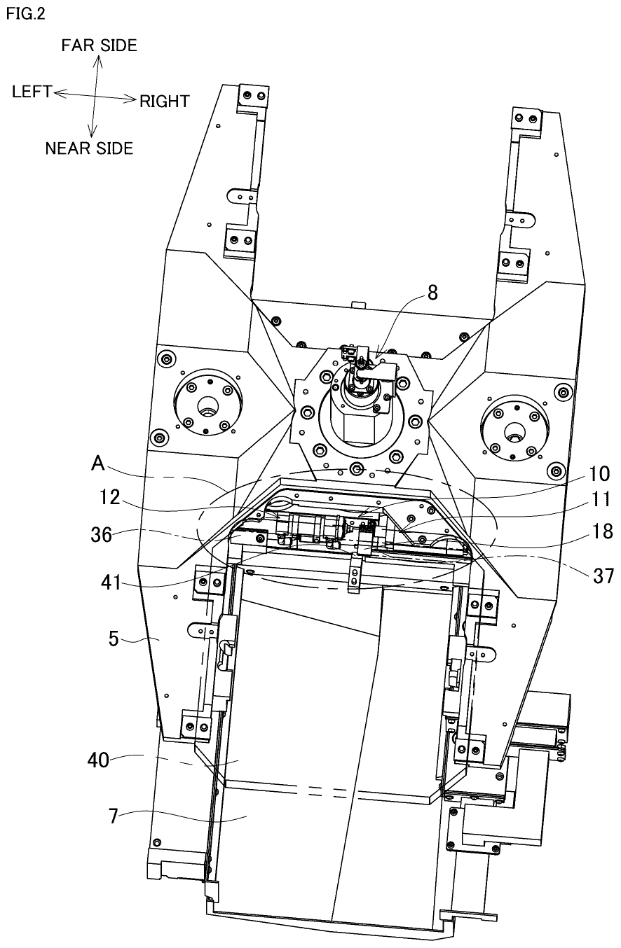

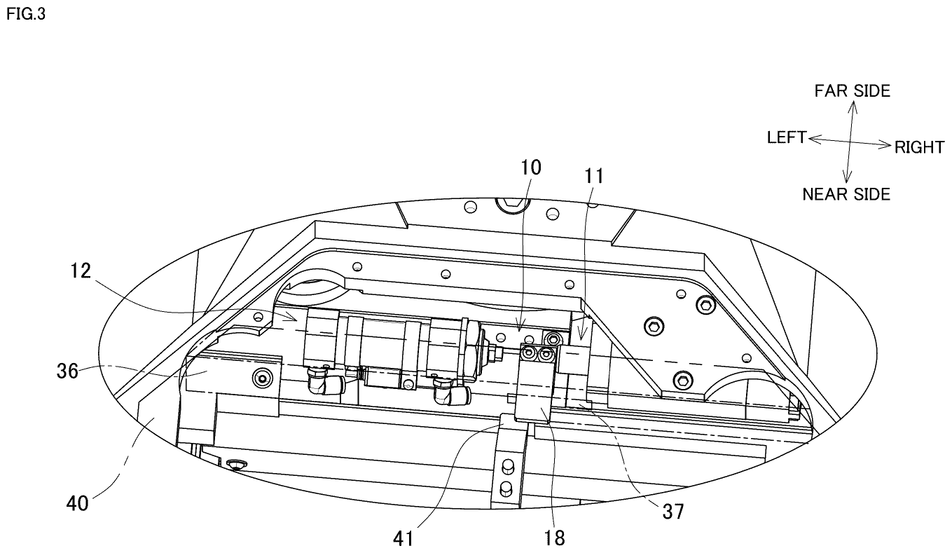

The locking body 14 includes a round bar-shaped input and output shaft 15 extending in a left-right direction and an anti-rotation shaft 16. The input and output shaft 15 and the anti-rotation shaft 16 are horizontally arranged side by side, and respective rear-end portions of the input and output shaft 15 and the anti-rotation shaft 16 are coupled via an adapter 17 such that they become parallel in a depth direction. In addition, a left-end portion, which is a forward end, of the input and output shaft 15 is housed to be movable backward and forward in the left-right direction in a state where it penetrates the case 13 and protrudes from a front surface (a left side in FIG. 4) of the case 13. As illustrated in FIGS. 2 and 3, an inverted L-shaped tip-over restraint hook 18 extending from a far side to a near side is disposed at the left-end portion of the input and output shaft 15. Since the input and output shaft 15 and the anti-rotation shaft 16 coordinate via the adapter 17, a space that allows backward and forward movement of the anti-rotation shaft 16 and the adapter 17 in the left-right direction is formed in the case 13. A right-end portion of the space is sealed by a rear lid 19. In addition, a ring-shaped stopper 20 is formed in a middle portion of the input and output shaft 15. At a left-end portion of the case 13, a front lid 21 is disposed such that the front lid 21 comes in contact with the stopper 20 to restrict the amount of protrusion of the input and output shaft 15. The input and output shaft 15 and the anti-rotation shaft 16 are pivotally supported by respective plain bearings 22 in the case 13. Furthermore, a protruding part of the input and output shaft 15 out of the case 13 is sealed with a dust seal 23 to inhibit foreign matter intrusion into an inside of the case 13.

In the case 13, a large-diameter hole 24 where the stopper 20 is movable backward and forward is formed in a housing part of the input and output shaft 15. A coil spring 25, as a biasing unit, externally mounted on the input and output shaft 15 is housed in the large-diameter hole 24 at a right side of the stopper 20. Therefore, in the locking body 14 in an ordinary state, the coil spring 25 pushes the stopper 20 to the left, thereby biasing the stopper 20 to an advanced position where it comes in contact with the front lid 21.

As described above, the input and output shaft 15 is restrained such that it cannot move in any direction other than the left-right direction, which is the axial direction, by the front lid 21 and the plain bearing 22 attached to the case 13. Furthermore, the input and output shaft 15 is biased to the left direction by the coil spring 25. In addition, the anti-rotation shaft 16 is retained by the plain bearing 22 attached to the case 13. Therefore, the movement of the anti-rotation shaft 16 in any direction other than the left-right direction, which is the axial direction, is also restrained. Furthermore, the input and output shaft 15 and the anti-rotation shaft 16 are fixed via the adapter 17. Therefore, the input and output shaft 15 can move in the left-right direction, while its rotation in the tangential direction is restricted by the anti-rotation shaft 16. Thus, a posture of the tip-over restraint hook 18 is maintained.

In addition, as illustrated in FIGS. 2 and 3, an L-shaped pallet side hook 41, which extends inward with the pallet 40 loaded on the fork portion 5, is disposed on a lower surface of the pallet 40. When the input and output shaft 15 of the locking body 14 is at the advanced position, the tip-over restraint hook 18 of the input and output shaft 15 engages with the pallet side hook 41. Accordingly, even if the pallet 40 starts to tip over due to centrifugal force when the turning arm 4 turns for exchanging the pallet 40, the pallet side hook 41 can get caught on the tip-over restraint hook 18, inhibiting the pallet 40 from tipping over.

On the other hand, in the unlocking portion 12, a tip-over restraint release cylinder 30 is supported horizontally on the base 7 via a bracket 31. As illustrated in FIG. 4, the tip-over restraint release cylinder 30 has a piston 33 in a cylinder chamber 32. In the piston 33, a right-end portion, which is a forward end of a cylinder rod 34 positioned on a coaxial extended line of the input and output shaft 15 of the locking portion 11 with the turning arm 4 descended, is protruded in the right direction. By supplying a predetermined driving force, such as compressed air, to the cylinder chamber 32 at the front and rear of the piston 33, the piston 33 can be moved backward and forward in the left-right direction, which is the axial direction, to move the cylinder rod 34 backward and forward. A protruding part of the cylinder rod 34 in the tip-over restraint release cylinder 30 may be sealed with a shielding member, such as a dust seal 35, to inhibit foreign matter intrusion into an inside of the tip-over restraint release cylinder 30.

As indicated by dash-dotted lines in FIGS. 2 and 3, the locking portion 11 is covered by a cover 36 with an L-shaped cross section attached to the fork portion 5. The cover 36 is formed also to cover the unlocking portion 12 when the turning arm 4 is stationary. Furthermore, a through-bore 37 is formed in the cover 36. The through-bore 37 allows the movement of the tip-over restraint hook 18 in association with the backward and forward movement of the input and output shaft 15, and an engaging portion of the tip-over restraint hook 18 with the pallet side hook 41 protrudes from an inside of the cover 36 to the outside. In the through-bore 37, the protruding part of the tip-over restraint hook 18 to the outside of the cover 36 may be sealed with a shielding member to inhibit foreign matter intrusion into the inside of the cover 36.

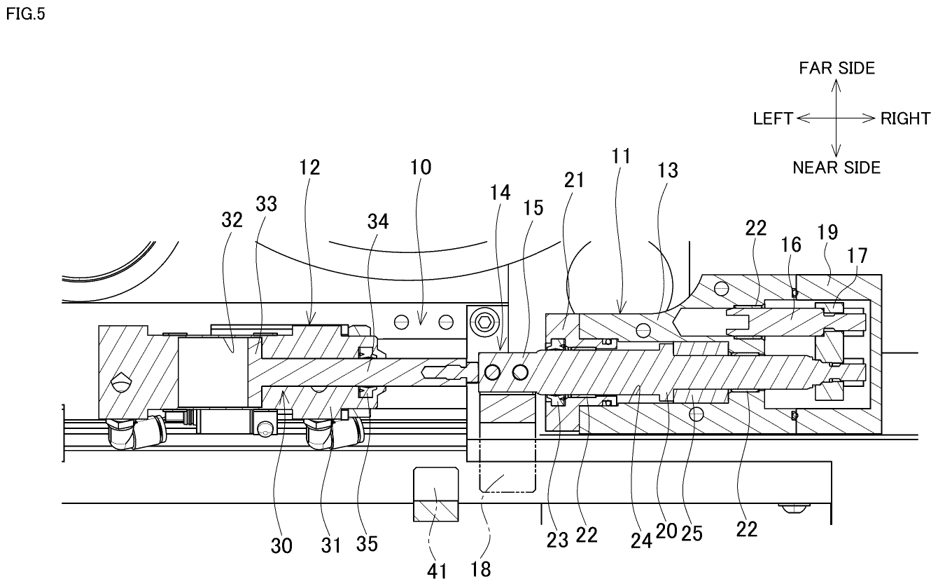

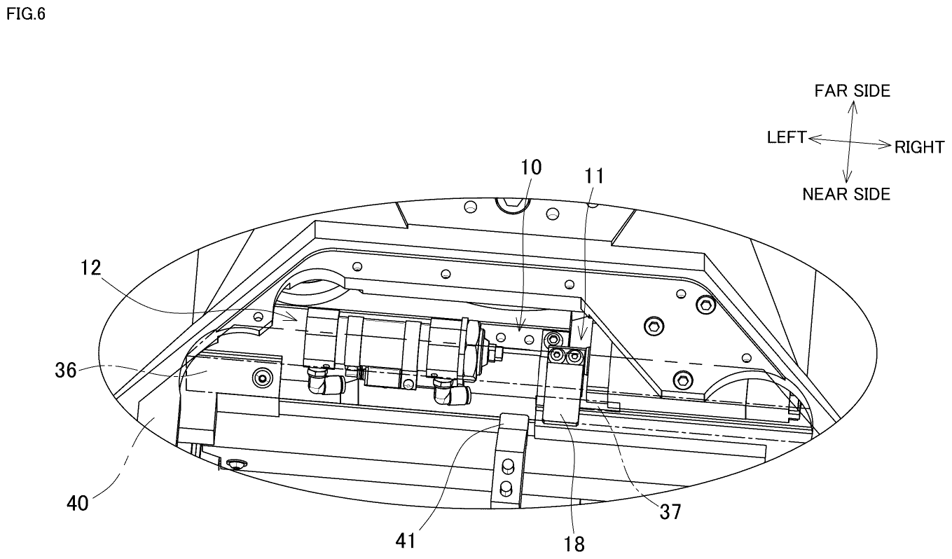

In a state illustrated in FIG. 4, the piston 33 moves to the left, and the cylinder rod 34 is positioned at a retracted position. At the retracted position, the cylinder rod 34 is separated from the input and output shaft 15 at the advanced position. When the piston 33 moves to the right side by driving force, as illustrated in FIGS. 5 and 6, the cylinder rod 34 comes into contact with the input and output shaft 15 and directly pushes the input and output shaft 15 into the case 13 of the locking body 14. As a result, when the input and output shaft 15 is pushed into the case 13, the tip-over restraint hook 18 also moves to the right side, releasing the engagement of the tip-over restraint hook 18 with the pallet side hook 41. The position of the input and output shaft 15, which is pushed by the cylinder rod 34 to release the engagement of the tip-over restraint hook 18 with the pallet side hook 41, is a retracted position of the input and output shaft 15 in the disclosure. In addition, the position of the cylinder rod 34 in a state where the input and output shaft 15 is moved to the retracted position is a protruding position of the cylinder rod 34 in the disclosure.

In the automatic pallet changer 1 configured as above, in normal operation where the pallet 40 is loaded on the fork portion 5, the piston 33 of the unlocking portion 12 is positioned at the retracted position of the cylinder chamber 32 by pneumatic pressure, as illustrated in FIG. 4, in the pallet tip-over restraint mechanism 10. Specifically, the cylinder rod 34 is separated from the input and output shaft 15. On the other hand, in a state where the cylinder rod 34 is separated from the input and output shaft 15, the locking body 14 is positioned at the advanced position in the locking portion 11. In this state, the tip-over restraint hook 18 disposed on the input and output shaft 15 engages with the pallet side hook 41 of the pallet 40. Hereinafter, the state where the tip-over restraint hook 18 engages with the pallet side hook 41 is defined as a locked state of the pallet 40.

In the locked state of the pallet 40, even when the turning arm 4 ascends and turns horizontally for exchanging the pallet 40, the engagement of the tip-over restraint hook 18 with the pallet side hook 41 is maintained. Therefore, the pallet 40 tipping over can be inhibited, and the occurrence of failures, such as misalignment, inclination, and drop, can be reduced.

On the other hand, when the pallet 40 is removed at the setup station 2, the piston 33 in the unlocking portion 12 advances by pneumatic pressure to protrude the cylinder rod 34. Then, in the locking portion 11, as illustrated in FIGS. 5 and 6, the locking body 14 is pushed into the case 13 together with the input and output shaft 15. As a result, the tip-over restraint hook 18 of the input and output shaft 15 moves to the right direction until it does not overlap with the pallet side hook 41 in the top view. Specifically, the engagement state of the tip-over restraint hook 18 with the pallet side hook 41 is released. Hereinafter, the state where the engagement state of the tip-over restraint hook 18 with the pallet side hook 41 is released is defined as an unlocked state of the pallet 40. By setting the pallet 40 to the unlocked state, the pallet 40 can be removed from the fork portion 5 without the tip-over restraint hook 18 interfering with the pallet side hook 41. Therefore, in the unlocked state, for example, when an FMS device lifts the pallet 40, the tip-over restraint hook 18 will not get caught on the pallet side hook 41, enabling smooth use of the FMS.

When a pallet 40 is loaded again, the piston 33 is retracted, and the cylinder rod 34 is also retracted. As the cylinder rod 34 retracts, the input and output shaft 15 returns to the advanced position together with the locking body 14 by the biasing of the coil spring 25. The input and output shaft 15 advances, causing the tip-over restraint hook 18 to move and engage with the pallet side hook 41. Accordingly, the newly loaded pallet 40 can be fixed.

As described above, in the automatic pallet changer 1 and the pallet tip-over restraint mechanism 10, the cylinder rod 34 is arranged on the coaxial extended line of the input and output shaft 15. Therefore, the cylinder rod 34 comes in contact with or is separated from the input and output shaft 15 in the axial direction in both the locked state and the unlocked state of the pallet 40 to move the input and output shaft 15 back and forth only in the axial direction. Specifically, no external force is applied to the input and output shaft 15 and the coil spring 25 in a diagonal direction with respect to the axial direction. Accordingly, since edge loading is less likely to occur on the plain bearing 22 to be able to inhibit uneven wear, the automatic pallet changer 1 and the pallet tip-over restraint mechanism 10 are excellent in durability. In addition, both the input and output shaft 15 and the cylinder rod 34 are sealed with the dust seals 23, 35 and internal mechanisms of the locking portion 11 and the unlocking portion 12 are not exposed. Furthermore, the pallet tip-over restraint mechanism 10 itself is covered by the cover 36. Accordingly, the automatic pallet changer 1 and the pallet tip-over restraint mechanism 10 are also excellent in dust-proof performance. Moreover, since it is only necessary to arrange the two shafts, namely, the input and output shaft 15 and the anti-rotation shaft 16, horizontally and in parallel in the locking portion 11, the pallet tip-over restraint mechanism 10 becomes compact in a height direction and can be installed with a small space. Therefore, the pallet tip-over restraint mechanism 10 can also be applied to an APC with a restriction in the up-down direction.

The configuration of a tool main spindle device in the disclosure is not limited in any way to the aspects described in the above embodiments, and can be appropriately changed as necessary without departing from the spirit of the invention.

For example, in the locking portion, the structure of the input and output shaft and the anti-rotation shaft is not limited to the above form, and it can have a square bar shape or a plate shape instead of a round bar shape. If the input and output shaft has a square bar shape or a polygonal bar shape and can be stopped from rotating in the tangential direction by itself, the anti-rotation shaft may be omitted. The coupling structure of both shafts in the locking portion can be appropriately changed. Without using an adapter, for example, the end portion of one shaft may be folded in an L-shape and coupled to the other shaft. Furthermore, in the locking portion, for example, a protrusion that protrudes in the left-right direction may be formed on the adapter as an anti-rotation shaft. Additionally, it is preferable that the input and output shaft and the anti-rotation shaft are arranged to be horizontal and parallel, but they may be arranged one above the other. Moreover, the input and output shaft and the anti-rotation shaft may include different structures.

In addition, the coil spring may be disposed on the anti-rotation shaft instead of the input and output shaft, or it may be disposed on both the input and output shaft and the anti-rotation shaft. Furthermore, the locking portion may have a structure in which a biasing unit such as a coil spring is disposed at the rear of the adapter to bias the whole locking body.

In addition, the engagement unit between the pallet and the locking portion indicated as the tip-over restraint hook and the pallet side hook is not limited to the hook shape as long as the locking portion can engage with the pallet. For example, after forming a projecting piece downward from the lower surface of the pallet, an insert-receiving portion, such as a through hole or a closed-end hole, may be provided in the projecting piece, and an insertion portion insertable into the insert-receiving portion may be disposed on the input and output shaft of the locking portion. Furthermore, the insert-receiving portion may be provided in the pallet itself.

Also, in the unlocking portion, the shape of the cylinder rod can be changed, similarly to the input and output shaft. Further, in the unlocking portion, the driving force of the cylinder rod is not limited to air. In addition, the unlocking portion may be disposed on the lower surface of the fork portion.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A pallet tip-over restraint mechanism disposed in an automatic pallet changer, the automatic pallet changer including a turning arm with fork portions at both ends of the turning arm on a base of the automatic pallet changer and being configured to exchange a pallet loaded on the fork portion by horizontal turning and ascent and descent operations of the turning arm, the pallet tip-over restraint mechanism engaging with the pallet when the turning arm turns horizontally to inhibit the pallet from tipping over, the pallet tip-over restraint mechanism comprising
a locking portion disposed on a lower surface of the fork portion; and
an unlocking portion disposed below the fork portion, wherein
the locking portion includes an input and output shaft and a biasing unit, the input and output shaft is disposed to be movable backward and forward in an axial direction with rotation in a tangential direction restricted and engageable with the pallet at an advanced position, and the biasing unit biases the input and output shaft to the advanced position, and
the unlocking portion includes, on a base, a cylinder rod disposed at a position in front of the input and output shaft with the turning arm descended and movable between a protruding position and a retracted position, the cylinder rod pushes the input and output shaft into a retracted position from the advanced position to release engagement of the pallet with the input and output shaft at the protruding position, and the cylinder rod at the retracted position is separated from the input and output shaft at the advanced position.

2. The pallet tip-over restraint mechanism according to claim 1, wherein
in the locking portion, the input and output shaft and the biasing unit are housed in a case disposed on the lower surface side of the fork portion, except for a forward end of the input and output shaft, and the forward end of the input and output shaft is sealed with a shielding member, and
in the unlocking portion, the cylinder rod is housed in a tip-over restraint release cylinder disposed on the base, except for a forward end thereof, and the forward end of the cylinder rod is sealed with a shielding member.

3. The pallet tip-over restraint mechanism according to claim 2, wherein
the locking portion includes an anti-rotation shaft housed in the case and disposed to be movable backward and forward integrally with the input and output shaft, and the anti-rotation shaft restricts rotation of the input and output shaft in the tangential direction.

4. The pallet tip-over restraint mechanism according to claim 3, wherein
the input and output shaft is coupled in parallel to the anti-rotation shaft.

5. The pallet tip-over restraint mechanism according to claim 3, wherein
the input and output shaft is horizontally arranged side by side with the anti-rotation shaft.

6. An automatic pallet changer including a turning arm with fork portions at both ends of the turning arm on a base of the automatic pallet changer and being configured to exchange a pallet loaded on the fork portion by horizontal turning and ascent and descent operations of the turning arm, the automatic pallet changer comprising
a pallet tip-over restraint mechanism that engages with the pallet when the turning arm turns horizontally to inhibit the pallet from tipping over, wherein
the pallet tip-over restraint mechanism includes a locking portion disposed on a lower surface of the fork portion and an unlocking portion disposed below the fork portion,
the locking portion includes an input and output shaft and a biasing unit, the input and output shaft is disposed to be movable backward and forward in an axial direction with rotation in a tangential direction restricted and engageable with the pallet at an advanced position, and the biasing unit biases the input and output shaft to the advanced position, and
the unlocking portion includes, on a base, a cylinder rod disposed at a position in front of the input and output shaft with the turning arm descended and movable between a protruding position and a retracted position, the cylinder rod pushes the input and output shaft into a retracted position from the advanced position to release engagement of the pallet with the input and output shaft at the protruding position, and the cylinder rod at the retracted position is separated from the input and output shaft at the advanced position.

7. The automatic pallet changer according to claim 6, wherein
in the locking portion, the input and output shaft and the biasing unit are housed in a case disposed on the lower surface side of the fork portion, except for a forward end of the input and output shaft, and the forward end of the input and output shaft is sealed with a shielding member, and
in the unlocking portion, the cylinder rod is housed in a tip-over restraint release cylinder disposed on the base, except for a forward end thereof, and the forward end of the cylinder rod is sealed with a shielding member.

8. The automatic pallet changer according to claim 7, wherein
the locking portion includes an anti-rotation shaft housed in the case and disposed to be movable backward and forward integrally with the input and output shaft, and the anti-rotation shaft restricts rotation of the input and output shaft in the tangential direction.

9. The automatic pallet changer according to claim 8, wherein
the input and output shaft is coupled in parallel to the anti-rotation shaft.

10. The automatic pallet changer according to claim 8, wherein
the input and output shaft is horizontally arranged side by side with the anti-rotation shaft.
